(19) United States
(12) Patent Application Publication
(10) Pub. No.: US 2025/0077956 A1
(43) Pub. Date: Mar. 6, 2025

(54) SYSTEM AND METHOD FOR AUTOMATIC WELL INTEGRITY LOG INTERPRETATION VERIFICATION

(71) Applicant: SAUDI ARABIAN OIL COMPANY, Dhahran (SA)

(72) Inventors: Mohamed Larbi Zeghlache, Al Khobar (SA); Chicheng Xu, Houston, TX (US); Yahia Ahmed Eltaher, Dhahran (SA)

(73) Assignees: SAUDI ARABIAN OIL COMPANY, Dhahran (SA); ARAMCO SERVICES COMPANY, Houston, TX (US)

(21) Appl. No.: 18/459,382

(22) Filed: Aug. 31, 2023

(51) Int. Cl. G06N 20/00

(52) U.S. Cl. CPC G06N 20/00

(57) ABSTRACT

Systems and methods for automatic well integrity log interpretation verification are disclosed. The methods include obtaining a first dataset comprising casing thickness profiles and associated electromagnetic [EM]data from at least a first hydrocarbon well having a casing; selecting a training dataset using at least a subset of the casing thickness profiles and a subset of the associated EM data; and training, using the training dataset, a machine learning network to produce a predicted corrosion log of a target section of a second hydrocarbon well from measured EM data from the second hydrocarbon well.

### BACKGROUND

Well log data acquired in a borehole, such as a hydrocarbon borehole, as well as legacy data from archives, may be processed to evaluate the effects of casing corrosion within the borehole. For example, corrosion log data from electromagnetic signal decay may be indicative of metal loss across the well casing. The raw electromagnetic data typically undergoes multiple steps of preprocessing, including filtering, cleaning, editing, and normalization. Next, the preprocessed data may be further processed with inversion techniques, or analyzed with statistical techniques (e.g., correlation).

Cognitive computing systems in general, and machine learning (ML) methods, specifically, are recent trends in data processing and interpretation applications. For example, convolutional neural networks (CNNs) have been successfully deployed to address a variety of challenges in several fields, such as image features recognition, and Genetic Algorithms (GA) have proven to be robust methods for global search and optimization.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments are disclosed related to methods for automatic well integrity log interpretation verification. The methods include obtaining a first dataset comprising casing thickness profiles and associated electromagnetic data from at least a first hydrocarbon well having a casing; selecting a training dataset using at least a subset of the casing thickness profiles and a subset of the associated EM data; and training, using the training dataset, a machine learning network to produce a predicted corrosion log of a target section of a second hydrocarbon well from measured EM data from the second hydrocarbon well.

In general, in one aspect, embodiments are disclosed related to methods for automatic well integrity log interpretation verification. The methods include obtaining a dataset comprising measured target electromagnetic data from at least a target section of a target hydrocarbon well having a casing; predicting, using a machine learning network trained to produce a predicted corrosion log from measured EM data, a predicted corrosion log for the target section of the target hydrocarbon well from the measured target EM data; detecting areas of anomalous corrosion in the predicted corrosion log; and performing, using a casing repair tool, corrosion remediation on the casing based, at least in part, on the detected areas of anomalous corrosion.

In general, in one aspect, embodiments are disclosed related to systems configured for automatic well integrity log interpretation verification. The systems include a borehole logging tool, configured to obtain a dataset, wherein the dataset comprises target electromagnetic data from at least a target section of a target hydrocarbon well having a casing; and a machine learning network trained to produce a predicted corrosion log for the target section of the target hydrocarbon well from the dataset.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a well system and casing in accordance with one or more embodiments.

FIG. 2 shows a workflow in accordance with one or more embodiments.

FIG. 3 shows a forward model and inversion in accordance with one or more embodiments.

FIG. 4 shows a neural network in accordance with one or more embodiments.

FIG. 5 shows the training and solution of a machine learning network in accordance with one or more embodiments.

FIG. 6A shows a flowchart describing process of obtaining a training dataset and training a machine learning network in accordance with one or more embodiments.

FIG. 6B shows a flowchart describing obtaining a second dataset, using it to produce a corrosion log with a machine learning network, detecting a corrosion area, and performing corrosion remediation in accordance with one or more embodiments.

FIG. 7 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

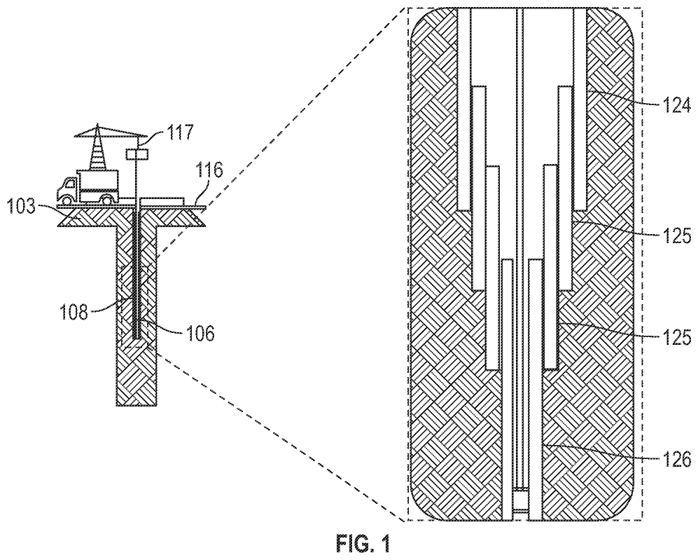

In the following description of FIGS. 1-7, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a well log dataset” includes reference to one or more of such well log datasets.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

A machine learning [ML]network and associated method of use is presented for the automated interpretation of EM log data. Interpretation is defined herein as the determination of properties of a system given a dataset related to that system. Through training, the ML network is taught to mimic the physics of a measurement process and perform the function of an EM inversion. Both one-dimensional EM data (e.g., multiple raw/processed data channels) and two-dimensional EM data (e.g., raw/processed two-dimensional images) may be converted into interpreted thickness profiles (i.e., corrosion logs) for one casing, or each of a plurality of concentric casings using the ML network. Unlike conventional methods for EM log data interpretation, the ML network is independent of input from well log analysts and insensitive to inversion parameter changes. “Parameter changes” refer to the need to reparametrize an inversion based on where in the borehole the interpretation is taking place. I.e., if the number or grade of casings used in a particular zone of the borehole changes, the inversion would need to be reparametrized to reflect this. Thus, the disclosed ML network is an improvement over existing processes for achieving the same result for at least the reasons of speed and repeatability.

In order to describe the systems and methods of this invention, it is necessary to provide background for the well system, since all measurements and interpretation occur within a well. FIG. 1 shows a well system in accordance with one or more embodiments. Although the well system shown in FIG. 1 describes a well on land, the well system may also be a marine well system. The example of the well system shown in FIG. 1 is not meant to limit the present disclosure.

More specifically, FIG. 1 shows a borehole (108) that may be drilled into the subsurface (103) by a drill bit attached by a drillstring to a drill rig located on the Earth's surface (116). A borehole (108) corresponds to the drilled portion of the well that exposes rock formations. The borehole trajectory is the path in three-dimensional space that the well is drilled through the subsurface (103) to a hydrocarbon reservoir. During drilling, pipe, called casing, may be lowered into a borehole (108) and cemented into place. The casing is designed to withstand forces from formation collapse and tensile failure, as well as chemically corrosion. Casing may be created with male threads, female threads, or with male threads on one end and female threads on the other end. Casing may be used to protect freshwater formations, isolate formations with significantly different pressure gradients, isolate formations to prevent the crossflow of formation fluid, and to provide a means of maintaining control of formation fluids and pressure as a well is being drilled. The operation of installing casing into the borehole (108) is called “running pipe.” Casing is usually manufactured from plain carbon steel that is heat-treated to varying strengths but may be specially fabricated to be composed of stainless steel, aluminum, titanium, fiberglass, and other materials. The diameter of casing may decrease with depth in the borehole (108), where larger diameter casing (124) is installed higher in the column, followed by intermediate diameter casing (125), and then smaller diameter casing (126) further down until a zone of production is reached.

Tool strings (106) contain sensors and may be lowered into boreholes (108) in the oil and gas industry for a variety of reasons, including to perform well logging, remediation, etc. The tool string (106) is inserted and retrieved from the borehole (108) with a line. The sensors usually require power while in the borehole (108) to perform their functions. This power may come from a variety of sources (e.g., electrical, mechanical, battery, etc.). Wireline is an electrically conductive cable usually comprising helically twisted wires surrounding an insulated conductive core. Electrical power may be passed along wireline from the surface (116) to the sensor. The wireline may also be used for communication between the surface (116) and the sensor in the borehole (108). Alternatively, a winch (117) at the surface (116) may generate mechanical power and transmit it down the borehole (108) through steel cables known as slicklines. However, slicklines are normally not configured to deliver electrical power. Therefore, when using slickline, power for sensors in the borehole (108) is usually provided by batteries. Coiled tubing, a continuous length of pipe wound on a spool, is widely used in place of slickline or wireline in the case of a highly deviated or horizontal well. The coiled tubing is forced through the borehole (108) to access the targeted interval.

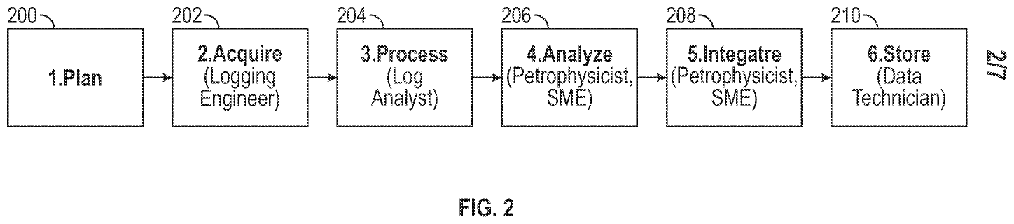

FIG. 2 presents a typical data workflow for well log data acquisition and processing. The workflow may be defined to include six major steps: planning (200) the acquisition of data, acquiring (202) the data in the field, processing (204) the data, analyzing (206) the data, integrating (208) the data (i.e., combining with other data), and storing (210) the data. Planning (200) is performed by a group that may consist of the manager of a business unit along with a team of drilling professionals. Acquiring (202) data is done by a logging engineer. Processing (204) the data is carried out by a log analyst. Analyzing (206) and integrating (208) the data is done by a petrophysicist or a subject matter expert (SME), where the processed one-dimensional or two-dimensional EM data from Step 204 is converted to a final result. Storing (210) the data is done by a data technician.

Typically, acquired data is processed (204) and then analyzed (206) to produce the interpreted data. The interpretation may be done manually or with software tools. Despite already being processed in the data processing (204) step, the interpreted data nonetheless may be erroneously referred to as “raw data,” in subsequent analysis. The quality of interpreted data may be affected by hardware calibration, errors in standard operating procedures and real-time data monitoring, lack of wellsite quality control, and post-acquisition data normalization. For example, in the data processing (204) step, it is routine that log analysts perform a defined sequence of operations without knowledge of the physics of the measurement process, including filtering, clipping, splicing, editing, and normalizing.

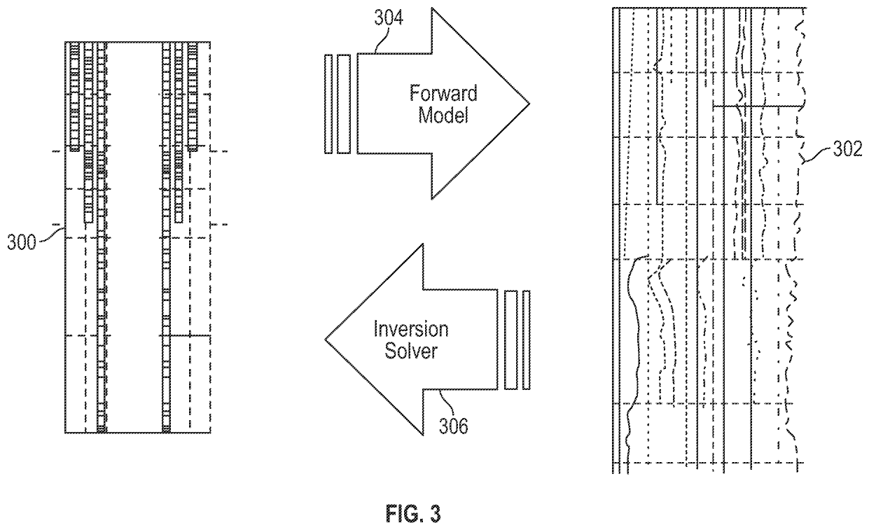

There are three important and interrelated concepts that are essential for items 202 through 206 of the workflow in FIG. 2. The first is tool characterization, where experiments are first conducted in known environments to establish the reference response of the tool. This leads to the second concept, a forward model (304) that specifies what the expected raw data will be for a range of subsurface physical property configurations. The forward model (304) encapsulates the physics of the measuring process, and may be used for pre-job planning (200) and verification of tool response in an environment other than the one used for characterization. The third concept is the solution of the inverse problem, commonly known as the inversion. With inversion, the recorded raw data is fed into an algorithm that produces a parametric model of the casing that is consistent with the data. For the example of corrosion logs (300), raw EM data (time delay, amplitude, and decay of recoded signals) may be inverted to estimate the spatial thickness distribution (i.e., a corrosion log (300)) for a borehole completion. FIG. 3 illustrates the concept of inversion. The corrosion log (300) on the left side of FIG. 3 shows the state of corrosion of the casing. The corrosion log (300) affects the data recorded in other well logs (302) containing other environmental data that are observed in the borehole (108), as shown on the right side of the figure. The forward model (304) takes corrosion logs (300) as input and produces their response in those other well log data. The inversion solver (306) takes observed well log data as input and transforms them back into a best-fitting, estimated corrosion log.

In accordance with one or more embodiments of the invention disclosed herein, the data interpretation inverse problem may be replaced by an ML network trained to estimate parameters without a priori knowledge of the measurement physics or the forward model (304). The novel ML network for converting EM data and other data to corrosion logs (300) uses the acquired raw data responses—in this case, 96 channels of amplitude data in millivolts—along with the known environmental data, such as casing sizes, depths, nominal thicknesses, casing tally, borehole pressure and temperature profiles, and cementing data. Other environmental data used in the training procedure may include geological data, geophysical data, drilling data, cementing data, open-hole and cased hole data. The datasets used in all training and testing may also be created through computer simulation. This may mean simulating casing data and then, from the casing data, simulating the EM data and other environmental data with a physics-based forward model (304). It may also mean taking real casing data observed in a borehole (108) and simulating, through the forward model (304), the EM and other environmental data that they are expected to produce. The geology data may include formation tops and lithology information. Formation tops give a depth reference for certain types of corrosion mechanisms that the ML network will learn and takes into account. For example, if a formation is known to be a water bearing aquifer, the ML network may learn electrochemical corrosion patterns from the raw EM data due to water exposure of external casings. The geophysical data may include rock mechanical properties and stress field information. Mechanical defects that result from stresses may be learned by the ML algorithm and translated into the interpreted results. The drilling, cementing, open-hole, and cased hole data may include logs, reports, and simulation models.

All, or a portion, of the above data may be used to train an ML network to produce an automated interpretation giving corrosion profiles for a single or concentric casing strings, as well as values of conductivity and magnetic permeability.

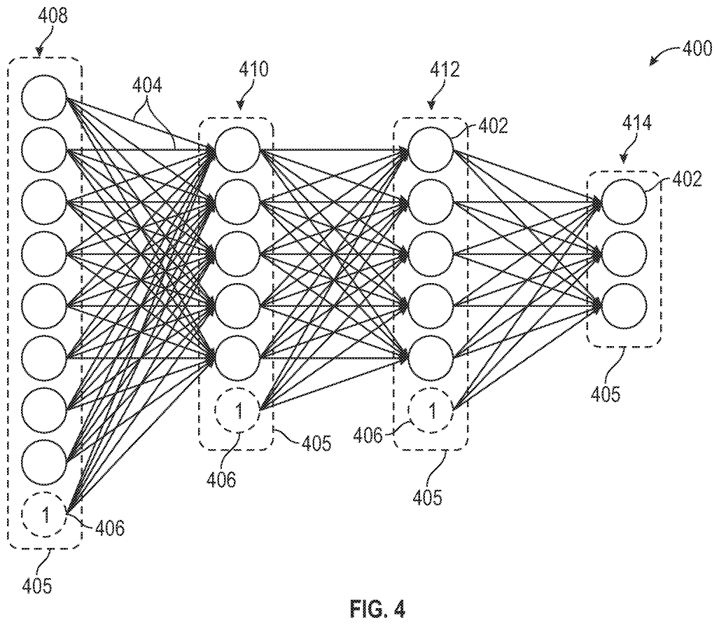

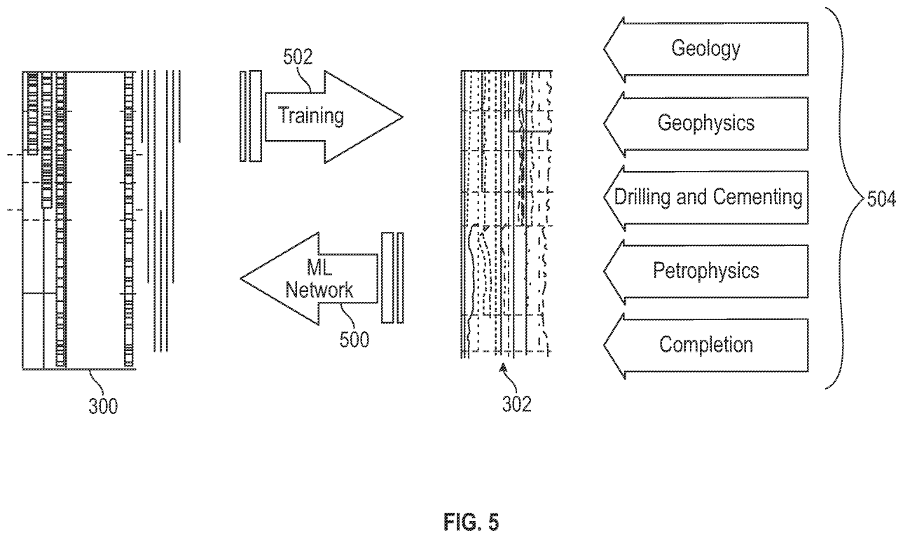

Since the ML network may be a neural network, a common ML method for inference, it is beneficial to review the structure of such a method. FIG. 4 shows a neural network (400). At a high level, a neural network (400) may be graphically depicted as comprising nodes (402), shown here as circles, and edges (404), shown here as directed lines connecting the circles. The nodes (402) may be grouped to form layers, such as the four layers (408, 410, 412, 414) of nodes (402) shown in FIG. 4. The nodes (402) are grouped into columns for visualization of their organization. However, the grouping need not be as shown in FIG. 5. The edges (404) connect the nodes (402). Edges (404) may connect, or not connect, to any node(s) (402) regardless of which layer (405) the node(s) (402) is in. That is, the nodes (402) may be fully or sparsely connected. A neural network (400) will have at least two layers, with the first layer (408) considered as the “input layer” and the last layer (414) as the “output layer.” Any intermediate layer, such as layers (410) and (412) is usually described as a “hidden layer”. A neural network (400) may have zero or more hidden layers, e.g., hidden layers (410) and (412). However, a neural network (400) with at least one hidden layer (410, 412) may be described as a “deep” neural network forming the basis of a “deep learning method.” In general, a neural network (400) may have more than one node (402) in the output layer (414). In this case the neural network (400) may be referred to as a “multi-target” or “multi-output” network.

Nodes (402) and edges (404) carry additional associations. Namely, every edge is associated with a numerical value. The numerical value of an edge, or even the edge (404) itself, is often referred to as a “weight” or a “parameter”. While training a neural network (400), numerical values are assigned to each edge (404). Additionally, every node (402) is associated with a numerical variable and an activation function. Activation functions are not limited to any functional class, but traditionally follow the form:

$$A = f ( {\sum }_{i ∈ ( i ncoming )} [ {( node v alue )}_{i} {( edge v alue )}_{i} ] ) , \qquad ( 1 )$$

where i is an index that spans the set of “incoming” nodes (402) and edges (404) and ƒ is a user-defined function. Incoming nodes (402) are those that, when viewed as a graph (as in FIG. 4), have directed arrows that point to the node (402) where the numerical value is computed. Functional forms of ƒ may include the linear function ƒ(x)=x, sigmoid function

$$f ( x ) = \frac{1}{1 + {e}^{- x}} ,$$

and rectified linear unit function ƒ(x)=max(0,x), however, many additional functions are commonly employed in the art. Each node (402) in a neural network (400) may have a different associated activation function. Often, as a shorthand, activation functions are described by the function f by which it is composed. That is, an activation function composed of a linear function f may simply be referred to as a linear activation function without undue ambiguity.

When the neural network (400) receives an input, the input is propagated through the network according to the activation functions and incoming node (402) values and edge (404) values to compute a value for each node (402). That is, the numerical value for each node (402) may change for each received input. Occasionally, nodes (402) are assigned fixed numerical values, such as the value of 1, that are not affected by the input or altered according to edge (404) values and activation functions. Fixed nodes (402) are often referred to as “biases” or “bias nodes” (406), and are depicted in FIG. 4 with a dashed circle.

In some implementations, the neural network (400) may contain specialized layers (405), such as a normalization layer, or additional connection procedures, like concatenation. One skilled in the art will appreciate that these alterations do not exceed the scope of this disclosure.

As noted, the training procedure for the neural network (400) comprises assigning values to the edges (404). To begin training, the edges (404) are assigned initial values. These values may be assigned randomly, assigned according to a prescribed distribution, assigned manually, or by some other assignment mechanism. Once edge (404) values have been initialized, the neural network (400) may act as a function, such that it may receive inputs and produce an output. As such, at least one input is propagated through the neural network (400) to produce an output. Recall that a given data set will be composed of inputs and associated target(s), where the target(s) represent the “ground truth”, or the otherwise desired output. The neural network (400) output is compared to the associated input data target(s). The comparison of the neural network (400) output to the target(s) is typically performed by a so-called “loss function”; although other names for this comparison function such as “error function” and “cost function” are commonly employed. Many types of loss functions are available, such as the mean-squared-error function. However, the general characteristic of a loss function is that it provides a numerical evaluation of the similarity between the neural network (400) output and the associated target(s). The loss function may also be constructed to impose additional constraints on the values assumed by the edges (404), for example, by adding a penalty term, which may be physics-based, or a regularization term. Generally, the goal of a training procedure is to alter the edge (404) values to promote similarity between the neural network (400) output and associated target(s) over the data set. Thus, the loss function is used to guide changes made to the edge (404) values, typically through a process called “backpropagation.”

The loss function will usually not be reduced to zero during training. And, once trained, it is not necessary or required that the neural network (400) exactly reproduce the output elements in the training data set when operating upon the corresponding input elements. Indeed, a neural network (400) that exactly reproduces the output for its corresponding input may be perceived to be “fitting the noise.” In other words, it is often the case that there is noise in the training data, and a neural network (400) that is able to reproduce every detail in the output is reproducing noise rather than true signal. The price to pay for using such a “perfect” neural network (400) is that it will be limited to fitting only the training data and not able to generalize to produce a realistic output for a new and different input that has never been seen by it before. An analog of this problem occurs when fitting a polynomial to data points. The higher the degree of the polynomial, the closer the resulting curve will be to fitting all the points (a high enough polynomial is guaranteed to fit all the points). However, higher degree polynomials will tend to diverge quickly away from the fit data point values—hence, a high degree polynomial will not exhibit generalizability.

For the purposes of producing a corrosion log (300) from other well data, the training of the neural network (400) in this case requires multiple input and output pairs. The input are the EM data and other environmental data (geology, geophysics, petrophysics, etc.); the output are the corrosion logs (300) corresponding to each input. These pairs may be obtained from a controlled laboratory environment where the state of corrosion of casing is known precisely. The pairs may also be obtained from other parts of the same well where interpretation will occur. In this case, the other parts of the well have already been interpreted and the state of corrosion is well known. These two examples do not limit the scope of the invention; pairs of training data may come from other sources such as, e.g., computer simulations, a different well, etc.

A sufficient number of input/output pairs must be obtained for the ML network to have accurate interpretational power. The exact quantity of pairs is often determined by trial and error, where a portion of input/output pairs are withheld for testing, and the ML network is trained on the rest. If the resulting ML network can successfully produce the output from the input in the testing pairs, the ML network may be deemed to have been trained with a sufficient number of training data. Other methods to determine the sufficient number of training data exist, and the example presented here does not limit this invention. Once trained, the ML network may be applied to the well data under consideration in order to produce a corrosion log (300).

The solution produced from the ML network (500) is illustrated in FIG. 5. The corrosion log (300) is shown on the left side of the figure. This time, the mapping from other environmental data (504) back into corrosion logs (300) is performed with the ML network (500). There is no forward model (304) in this case. Rather, a training procedure (502) is performed to tune the parameters of the ML network (500) such that, for a training data set consisting of matching pairs of corrosion logs (300) and other well logs, the other well logs will optimally produce the corrosion logs (300). The other environmental data (504) may represent data from a variety of sources related to geology, geophysics, drilling and cementing, petrophysics, and completion. In order for this method to be successful, pairs of raw and interpreted data, including environmental data (504), must exist for a sufficiently large number of wells. These pairs of data are used to train the ML network. Once data is obtained at a new well location, it is input into the ML network and output data (interpreted data) is generated automatically.

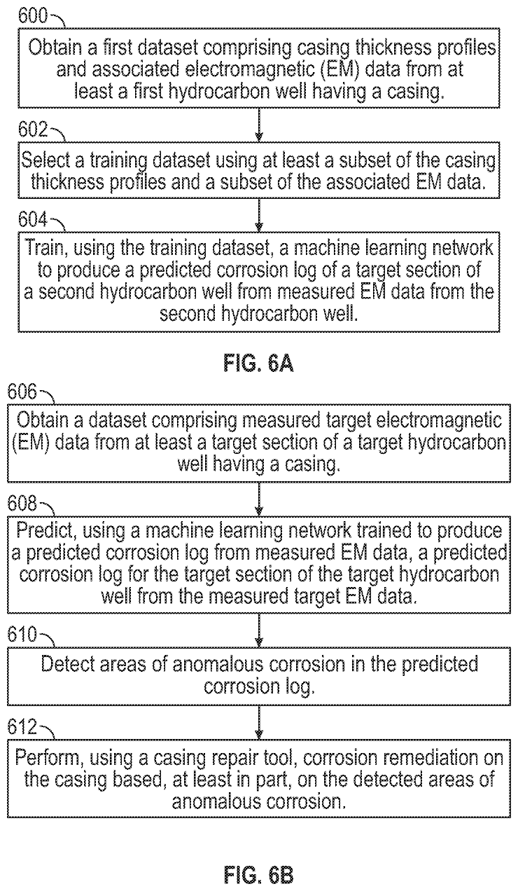

FIG. 6A shows a workflow of a first method for training an ML network (500) to produce a corrosion log (300) from measured well logs. In Step 600, a first dataset is obtained comprising casing thickness profiles and associated EM data from at least a first hydrocarbon well having a casing. The first dataset may be obtained from existing wells with borehole logging tools or from a historical database. Alternatively, a laboratory apparatus may be constructed to produce the training data, or a computer simulation may create the first dataset.

In Step 602, a training dataset is selected using at least a subset of the casing thickness profiles and a subset of the associated EM data. In some embodiments, the EM data may comprise an electromagnetic log or a two-dimensional image. Other environmental data (504) may be obtained along with the EM data. The environmental data (504) may include geological data, geophysical data, drilling data, cementing data, open-hole and cased hole data.

In the training dataset, the exact thickness and state of all casing (124) in three dimensions is known, and a suite of data is then obtained in the borehole (108) at the same locations where the casing thickness profile is known.

In Step 604, a machine learning network is trained, using the training dataset, to produce a predicted corrosion log of a target section of a second hydrocarbon well from measured EM data from the second hydrocarbon well. The ML network (500) may be supervised, semi-supervised, or unsupervised. The ML network (500) may be a recurrent neural network or other type of neural network (400). The weights in the neural network (400) are modified during training until the discrepancy between the input and output training data has been minimized.

FIG. 6B shows a workflow of a second method for applying an ML network (500) to produce a corrosion log (300) from measured well logs. In Step 606, in accordance with one or more embodiments, a dataset is obtained comprising measured target EM data from at least a target section of a target hydrocarbon well having a casing. The dataset may be obtained using a borehole logging tool. Other environmental data (504) may be obtained along with the EM data. The environmental data (504) may include geological data, geophysical data, drilling data, cementing data, open-hole and cased hole data. In some embodiments, the EM data may comprise an electromagnetic log or a two-dimensional image.

In Step 608, a corrosion log (300) is predicted for the target section of the target hydrocarbon well from the measured target EM data. This prediction is done using a machine learning network trained to produce a predicted corrosion log from measured EM data. The predicted corrosion log may comprise a three-dimensional representation of corrosion on a plurality of concentric sections of the casing.

In Step 610, areas of anomalous corrosion are detected in the predicted corrosion log. In Step 612, a corrosion remediation is performed, using a casing repair tool, on the casing based, at least in part, on the detected areas of anomalous corrosion.

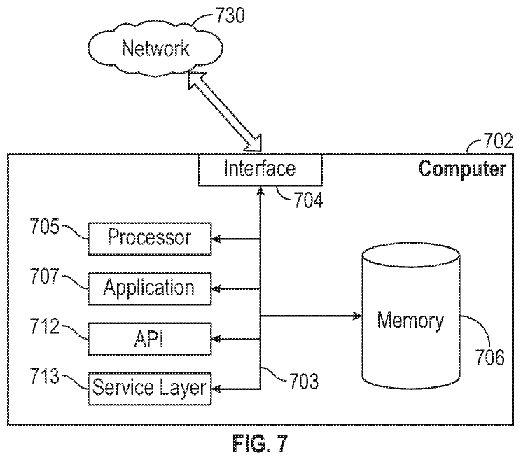

FIG. 7 depicts a block diagram of a computer system (702) used to provide computational functionalities associated with described algorithms, methods, functions, processes, flows, and procedures as described in this disclosure, according to one or more embodiments. The illustrated computer (702) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. The illustrated computer (702) is communicably coupled with a network (730). In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) from a client application (for example, executing on another computer (702)) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713)). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or another suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704) includes logic encoded in software or hardware (or a combination of software and hardware) and operable to communicate with the network (730). More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computer (702), wherein each computer (702) communicates over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a first dataset comprising casing thickness profiles and associated electromagnetic [EM] data from at least a first hydrocarbon well having a casing;
selecting a training dataset using at least a subset of the casing thickness profiles and a subset of the associated EM data; and
training, using the training dataset, a machine learning network to produce a predicted corrosion log of a target section of a second hydrocarbon well from measured EM data from the second hydrocarbon well.

2. The method of claim 1, wherein the first dataset further comprises environmental data.

3. The method of claim 2, wherein the environmental data comprises geophysical data.

4. The method of claim 1, further comprising obtaining the first dataset from computer simulations.

5. The method of claim 1, wherein the EM data comprise a two-dimensional image.

6. The method of claim 1, wherein training the machine learning network comprises a supervised learning based, at least in part, on the casing thickness profiles and the EM data.

7. The method of claim 1, wherein the EM data comprise an electromagnetic log.

8. The method of claim 1, wherein the machine learning network comprises a recurrent neural network.

9. The method of claim 1, wherein the corrosion log comprises a three-dimensional representation of corrosion on a plurality of concentric casing sections.

10. A method, comprising:
obtaining a dataset comprising measured target electromagnetic [EM] data from at least a target section of a target hydrocarbon well having a casing;
predicting, using a machine learning network trained to produce a predicted corrosion log from measured EM data, a predicted corrosion log for the target section of the target hydrocarbon well from the measured target EM data;
detecting areas of anomalous corrosion in the predicted corrosion log; and
performing, using a casing repair tool, corrosion remediation on the casing based, at least in part, on the detected areas of anomalous corrosion.

11. The method of claim 10, wherein the dataset further comprises environmental data.

12. The method of claim 11, wherein the environmental data comprises geophysical data.

13. The method of claim 10, wherein the target EM data comprise an electromagnetic log.

14. The method of claim 10, wherein the machine learning network comprises a recurrent neural network.

15. The method of claim 10, wherein the predicted corrosion log comprises a three-dimensional representation of corrosion on a plurality of concentric sections of the casing.

16. A system to produce a corrosion log, comprising:
a borehole logging tool configured to obtain a dataset, wherein the dataset comprises target electromagnetic [EM] data from at least a target section of a target hydrocarbon well having a casing; and
a machine learning network trained to produce a predicted corrosion log for the target section of the target hydrocarbon well from the dataset.

17. The system of claim 16, wherein the dataset further comprises environmental data.

18. The system of claim 16, further comprising a casing repair tool configured to remediate a portion of the casing based, at least in part, on an area of anomalous corrosion indicated by the predicted corrosion log.

19. The system of claim 16, wherein the target EM data comprise an electromagnetic log.

20. The system of claim 16, wherein the machine learning network comprises a recurrent neural network.
